(19) United States
(12) Patent Application Publication
(10) Pub. No.: US 2020/0225966 A1
(43) Pub. Date: Jul. 16, 2020

(54) UNIVERSAL VIRTUAL PROFESSIONAL TOOLKIT

(71) Applicant: CYTK LLC, San Anselmo, CA (US)

(72) Inventors: Bryan Levenson, San Anselmo, CA (US); Darr Aley, Ross, CA (US); Patrick Weinkam, San Francisco, CA (US); Jorge Fernando Olmos Assaf, Bariloche (AR); Luke Alan Stewart, Honeoye Falls, NY (US)

(73) Assignee: CYTK LLC, San Anselmo, CA (US)

(21) Appl. No.: 16/631,161

(22) PCT Filed: Jul. 16, 2018
(86) PCT No.: PCT/US2018/042332

§ 371 Date: Jan. 14, 2020

Related U.S. Application Data
(60) Provisional application No. 62/533,042, filed on Jul. 15, 2017.

(51) Int. Cl. G06F 9/451; G06F 11/36; G06F 9/455; G06F 8/35; G07C 5/00

(52) U.S. Cl. CPC G06F 9/453; G06F 11/3664; G07C 5/008; G06F 11/3636; G06F 8/35; G06F 9/45558

(57) ABSTRACT

A trained cross-functional process model and a subject-specific virtual assistant provide service professionals access to a body of knowledge that could understand their specific needs, automate service tasks, and provide them service information when they need it. By embedding artificial intelligence in the service context, the techniques in this disclosure support low cost inputs that allow novice service professionals and artificial intelligence to replace the services of a journeyman, particularly in service contexts where service quality and/or human judgement is irrelevant or only marginally relevant. The systems and methods herein may, in some implementations, benefit stakeholders, owners, and/or equity holders in many service contexts.

### TECHNICAL FIELD

The technical field relates to automation systems, and more particularly to an virtual service toolkit used to automate servicing of objects by a subject device.

### BACKGROUND

Many service professionals are disorganized when it comes to managing information. Automotive mechanics, for instance, may keep unstructured handwritten journals containing mechanics notes to track issues with automobiles being serviced. Many automotive mechanics may perform ad-hoc, structured, or unstructured Internet searches on laptops, mobile phones, or tablets to reference service issues.

Conventional techniques do not work for all service professionals. Novice service professionals, for instance, may lack extensive training in their fields, and as a result, may not have access to a detailed body of mechanics' notes or know how to search for answers to specific service-related problems. As another example, time-constrained service professionals may find accessing service information tedious or itself time-consuming. Many conventional techniques make it difficult for service professionals to access information when they need it. It would be beneficial if service professionals had access to a body of knowledge that could understand their specific needs, automate service tasks, and provide them service information when they need it.

### BRIEF DESCRIPTION OF THE FIGURES

FIG. 1 shows an example of a context-aware service environment.

FIG. 2 shows an example of a flowchart of a method for processing context-based servicing parameters.

FIG. 3 shows an example of a context-aware service toolkit.

FIG. 4A shows an example of a flowchart of a method for providing a user interaction to a context-aware professional diagnostic processing system.

FIG. 4B shows an example of a flowchart of a method for providing a user interaction to a context-aware professional diagnostic processing system.

FIG. 5A shows an example of a process model regulation system.

FIG. 5B shows an example of the operation of the process model regulation system.

FIG. 6 shows an example of a flowchart of a method for training a process model execution system.

FIG. 7 shows an example of a process model execution system.

FIG. 8 shows an example of a flowchart of a method for assigning a subject-specific virtual assistant to a subject using a process model execution system.

FIG. 9 shows an example of a software platform for a context-aware service environment.

### DETAILED DESCRIPTION

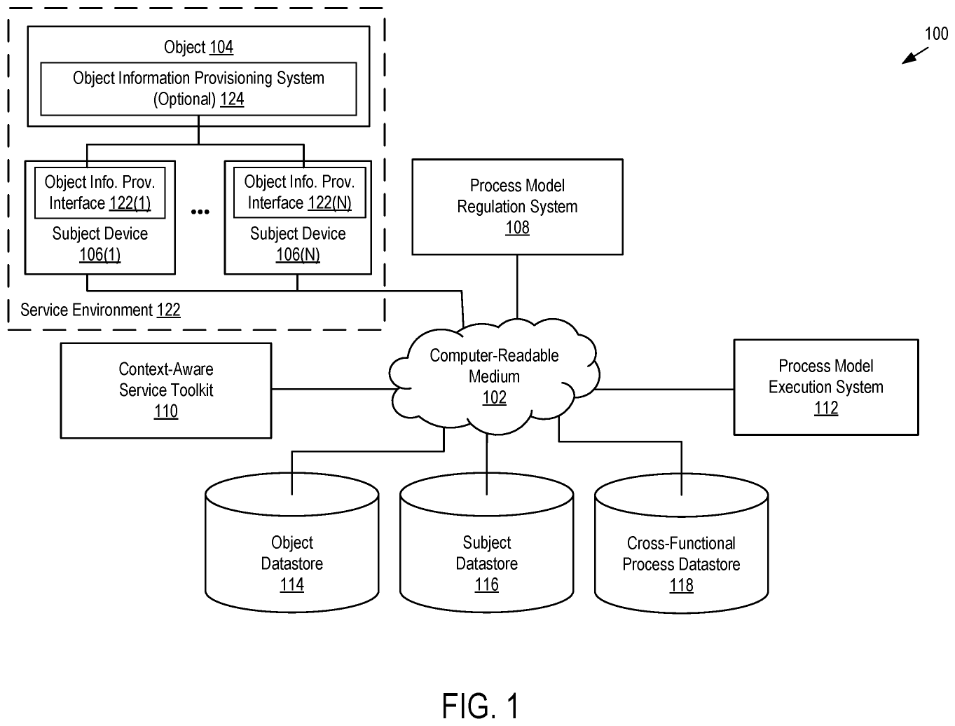

FIG. 1 shows an example of a context-aware service environment 100. The context-aware service environment 100 includes a computer-readable medium 102, an object 104, subject device(s) 106 (shown as subject device 106(1) through subject device 106(N)), a process model regulation system 108, a context-aware service toolkit 110, a process model execution system 112, an object datastore 114, a subject datastore 116, and a cross-functional process datastore 118. The object 104, subject device(s) 106, process model regulation system 108, context-aware service toolkit 110, process model execution system 112, object datastore 114, subject datastore 116, and cross-functional process datastore 118 may be coupled to one another and/or to modules not explicitly shown through the computer-readable medium 102.

In the example of FIG. 1, the object 104 may be coupled to the subject device(s) 106 over the computer-readable medium 102. The object 104 and the subject device(s) 106 may reside within a service environment 122. The service environment 122 may represent a physical space configured to allow the subject device(s) 106 and subject associated therewith to service the object 104.

The computer-readable medium 102 and other computer readable media discussed in this paper are intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable. The computer-readable medium 102 and other applicable systems or devices described in this paper can be implemented as a computer system or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), light emitting diode (LED), organic light emitting diode (OLED), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software or information to end user devices. The computing resources, software or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

In a specific implementation, the object 104 includes a physical object that can be serviced by a service professional. The term “service,” as used herein, may include repair, maintenance, management, changing or managing status(es) of, other activity etc. related to the object 104. In some implementations, the object 104 includes a vehicle (automobile, bus, train, airplane, ship, etc.), a medical device, an electronic device (computer, mobile phone, tablet, wireless device, a device with electronic components, etc.), and/or other physical objects. It is noted that while the examples provided thus far have been related to portable objects, in some implementations, the object 104 may include a stationary and/or large object that is not readily movable by a human being.

In the example of FIG. 1, the object 104 includes an object information provisioning system 124, which is optional. The object information provisioning system 124 is listed as optional because it is noted that some examples of the object 104 may not have the object information provisioning system 124 therein. The object information provisioning system 124 comprise hardware and/or software embedded in the object 104 and configured to provide diagnostic information related to the object 104 over the computer-readable medium 102. In some implementations, the object information provisioning system 124 may a chip embedded in the object 104. The object information provisioning system 124 may include an onboard diagnostic II (OBD-II) device, a digital multimeter (DMM), and/or other device.

In some implementations, the subject device(s) 106 comprises a mobile phone, a tablet computing device, a laptop computer, or a desktop computer. The subject device(s) 106 can include, by way of example but not limitation, any iOS device, any Android device, any Amazon Echo-line of smart home devices, Google Home smart speaker, or some other device.

The subject device(s) 106 may comprise a headset having a display, user interface controls, and/or other elements. In some implementations, the subject device(s) 106 comprises a heads-up display (HUD) or a head-mounted display (HMD). The subject device(s) 106 may comprise a general-purpose headset configured with specialized engines and/or datastores. In some implementations, the subject device(s) 106 may comprise a dedicated headset with specialized hardware that implements the context-aware service toolkit 110 and/or other modules. The subject device(s) 106 may comprise a mobile phone, tablet computing device, or other computer system with a depth camera. The subject device(s) 106 may be configured as an augmented reality (AR) or a mixed reality (MR) system. An AR/MR system, as used herein, may include any system configured to display virtual items superimposed over a depiction of a physical environment. A “virtual item,” as used herein, may comprise any computer-generated item that exists in a virtual world. In some implementations, virtual items may include servicing data, such as information used to service the object 104. The subject device(s) 106 may include a context-appropriate sensor component that processes context-appropriate data from the physical world. The subject device(s) 106 may also include a context-appropriate feedback component that provides context-appropriate feedback to the subject.

In the example of FIG. 1, each of the subject device(s) 106 includes an object information provisioning interface(s) 122. The object information provisioning interface(s) 122 may include one or more engines and/or datastores. As used herein, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described herein, or the engines through which the systems and devices described in this paper can be implemented, can be cloud-based engines. As used in this paper, a cloud-based engine is an engine that can run applications or functionalities using a cloud-based computing system. All or portions of the applications or functionalities can be distributed across multiple computing devices, and need not be restricted to only one computing device. In some implementations, the cloud-based engines can execute functionalities or modules that end users access through a web browser or container application without having the functionalities or modules installed locally on the end-users' computing devices. As used herein, a datastore, are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

The object information provisioning interface(s) 122 may include engines and/or datastores configured to interface with the object 104. The object information provisioning interface(s) 122 may receive from the object 104 service information that represents configurations, setups, conditions of, etc. the object 104 and/or components therein. In some implementations, the object information provisioning interface(s) 122 gather information directly, through an intermediary, etc. from the object information provisioning system 124. The object information provisioning interface(s) 122 may receive from and/or provide instructions to the context-aware service toolkit 110, as described further herein. In some implementations, the object information provisioning interface(s) 122 is configured by the context-aware service toolkit 110 to identify specific attributes of the object 104 to be serviced.

In some implementations, the context-aware service toolkit 110 processes instructions to service the object 104. The context-aware service toolkit 110 may provide a virtual toolkit that provides a subject with a body of service-related knowledge that the subject can use to service the object 104. In some implementations, the context-aware service toolkit 110 identifies specific and/or understands the parameters and/or ontologies subjects use to identify service-related problems and/or solutions to service-related problems.

In some implementations, the context-aware service toolkit 110 gathers object-specific servicing parameter values from a subject. An “object-specific servicing parameter value,” as used herein, may include any parameter that a subject uses identify problems and/or needs of the object 104. An object-specific servicing parameter value may be in a subject-specific format, e.g., a format that is specific to an ontological domain of a specific subject, or a domain-restricted format, e.g., a general format used to identify needs, problems, solutions, etc. related to the object 104.

As examples, the object-specific servicing parameter value may correspond to: specific words and/or sequences of words a subject uses to describe servicing problems and/or needs; specific actions inside or outside an application and/or sequences of actions that the subject uses to diagnose or identify servicing problems and/or needs and/or solutions; specific words, actions, etc. that an enterprise (e.g., business) associated with a subject would use to describe servicing problems and/or needs; etc.

As additional examples, the object-specific servicing parameter may comprise a natural language description of servicing problems and/or needs in natural language terms that are specific to a subject, an enterprise associated with the subject, etc. In some implementations, the object-specific servicing parameter may comprise specific patterns of usage of the subject device(s) 106 (specific Internet searches, specific requests for data, etc.) that are relevant to servicing problems and/or needs of the object 104.

The context-aware service toolkit 110 may further support a virtual assistant. A “virtual assistant,” as used herein, may include an intelligent virtual system that recognizes and provides solutions to a subject's servicing problems and/or needs. A virtual assistant may include virtual assistant influx capabilities and virtual assistant outflux capabilities that provide the ability to receive object-specific servicing parameters from subjects. In various implementations, a virtual assistant is configured in line with a subject-specific format that is appropriate for a subject.

In some implementations, a virtual assistant supported by the context-aware service toolkit 110 has natural language processing capabilities. To this end, the virtual assistant may recognize specific natural language patterns related to problems, needs, and/or solutions relevant to a subject. The virtual assistant may use these natural language patterns as the basis of inputs to the virtual assistant it supports.

A virtual assistant supported by the context-aware service toolkit 110 may be incorporated into an artificially intelligent chat program (e.g., a chatbot) that is executed on the context-aware service toolkit 110 or other systems. The artificially intelligent chat program may include a user interface that receives text input, images, natural language, etc. In various implementations, the artificially intelligent chat program is configured to address problems, needs, and/or solutions relevant to a subject. The artificially intelligent chat program may implement language and/or behavior recognition capabilities that recognize language and/or behavior patterns of a subject. These language and/or behavior pattern recognition capabilities may provide a subject with the impression that the subject is chatting to a human being. To this end, the language and/or behavior pattern recognition capabilities may provide textual and/or other interactions with a subject that are in a subject-specific format particular to the subject.

A virtual assistant supported by the context-aware service toolkit 110 may be configured to gather data from input devices, e.g., a camera, microphone, and/or user interface of the subject device(s) 106. In some implementations, the virtual assistant configures a camera to take pictures and/or video of parts of the object 104. In an automotive context, for instance, the virtual assistant supported by the context-aware service toolkit 110 may configure a camera to take pictures and/or video of a vehicle identification number (VIN), a license plate, a body, an engine, etc. of the object 104. In some implementations, the virtual assistant receives sounds and/or user input provided as a basis of servicing the object 104. As another example in the automotive context, the virtual assistant receives dictated mechanics' notes related to the object 104. As yet another example in the automotive context, the context-aware service toolkit 110 may receive written mechanics' notes related to the object 104.

In some implementations, the context-aware service toolkit 110 may incorporate a virtual assistant into AR/MR hardware. The context-aware service toolkit 110 may configure a display of AR/MR hardware to display virtual items that represent problems, needs, and/or solutions that are particular to a subject. As an example, the context-aware service toolkit 110 may configure the display to display text, images, and/or interactive virtual items that can be superimposed over a field of view of the object 104.

The context-aware service toolkit 110 may include hardware and/or software configured to reduce noise that in the service environment 122. In some implementations, the context-aware service toolkit 110 implements noise-reducing headphones that limit noise that typically occurs in a mechanics' workshop. The context-aware service toolkit 110 may further implement hardware and/or software filters that filter frequency ranges associated with noise in the service environment 122. The context-aware service toolkit 110 may implement light filters that allow its cameras to capture better photos or video of the object 104. The context-aware service toolkit 110 may implement user interface enhancement and/or accessibility modules (larger keyboards, more accessible elements, etc.) that allow a service professional to enter data easier or in an more accessible format while in a garage.

In some implementations, the process model regulation system 108 is configured to train the process model execution system 112 to implement a cross-functional process model. A “cross-functional process model,” as used herein, may refer to a model that models attributes of services provided by a service professional across two or more functional ontologies. A cross-functional process model may have a plurality of sub-process models, each of which model services provided by a service professional according to a particular ontology. Each sub-process model may model services in a subject-specific format that accords with a specific lexicography used by a specific service professional, for instance. In some implementations, one or more of the sub-process models may model services according to a domain-restricted format that models problems and/or solutions related to servicing the object 104 in a unified and/or canonical format.

In some implementations, a cross-functional process model includes preferences, behaviors, language patterns, and/or other attributes particular to a specific subject. A cross-functional process model may be customized to the preferences and/or behavior of a specific subject.

In some implementations, the process model regulation system 108 is configured to update a cross-functional process model implemented by the process model execution system 112. The process model regulation system 108 may gather from the vehicle product datastore(s) 116, the NLP data datastore(s) 118, the public vehicle data datastore(s) 120, and the other training datastore(s) 122 training content used to train the process model execution system 112 to implement a cross-functional process model. The cross-functional process model may model automobile mechanic notes, chatbot chatlogs, artificial intelligence such as voice recognitions and libraries of automotive voice commands, etc. The process model execution system 112 may include one or more engines or one or more datastores. The process model regulation system 108 may monitor language, behavior, other attributes, etc. of a subject. In some implementations, the process model regulation system 108 may provide updates (periodically, using an event trigger, etc.) to a cross-functional process model.

The process model execution system 112 may be configured to implement trained cross-functional process models. In some implementations, the process model execution system 112 designates cross-functional process models, identifies sub-process models, and manages subject-specific virtual assistants used for a cross-functional process model. A “subject-specific virtual assistant,” as used herein, may include a virtual assistant configured to facilitate automating servicing of the object 104 using a sub-process model specific to the subject device(s) 106. A subject-specific virtual assistant may be subject-specific in that it receives input and provides output in accordance with an ontology (e.g., a subject-specific format) of the subject device(s) 106. As examples, a subject-specific virtual assistant may accord with a specific language, a specific format of mechanics notes, or specific user experiences of a service professional.

The object datastore 114 may be configured to store data related to objects. In some implementations, the object datastore 114 may be configured to store vehicle product data. “Vehicle product data,” as used herein, may include any data that identifies a vehicle and/or a vehicle make/model. Examples of vehicle product data include data related to product part number, product manufacturer, product availability, product ship date, and/or product cost. In some implementations, the object datastore 114 contain vehicle product data that identifies past servicing of the object's 104. The object datastore 114 may also be configured to store public vehicle data. Examples of public vehicle data include vehicle identification number (VIN) information. VIN information may include any digital content that is readable by any system coupled to the computer-readable medium 102 and contains vehicle owner history, repair/service history, vehicle title history, vehicle recall information, vehicle manufacture identifier, vehicle make and model, etc. The object datastore 114 may further be configured to store other data related to the object 104.

The subject datastore 116 may be configured to store data related to subjects. In some implementations, the subject datastore 116 is configured to store NLP data. The NLP data may include any digital content that comprises lexical, semantic, syntactic, pragmatic, and inference information of English words/phrases. The NLP data may be retrieved by the process model execution system 112 and/or the process model regulation system 108 for search engine or recommender system applications. In some implementation, the NLP data may be retrieved by the process model execution system 112 and/or the process model regulation system 108 for text retrieval applications such language contextual analysis. The subject datastore 116 may also be configured to store a subject's preferences and/or settings related to a subject. The subject datastore 116 may store past behaviors and/or patterns of behavior, speech patterns, etc. of a subject.

The cross-functional process datastore 118 may be configured to store cross-functional process data. In some implementations, cross-functional process data may be stored and/or updated by the process model regulation system 108. Cross-functional process data may be retrieved by the process model execution system 112. As noted herein, the cross-functional process data may address needs and/or problems associated with the object 104, particularly those associated with servicing the object 104. The cross-functional process datastore 118 may also store parameters used for a virtual assistant.

In various implementations, the modules shown in FIG. 1 operate to support a cross-functional process model that enables a subject to use the context-aware service toolkit 110 to service the object 104. In a training phase, the process model regulation system 108 may train a cross-functional process model recognize patterns of problems, needs, and/or solutions relevant to specific subjects. The process model regulation system 108 may gather identifiers and/or parameters of specific objects that are likely to be serviced by a subject. The process model regulation system 108 may further gather terms, natural language patterns, patterns of behavior, and/or other patterns subjects use to analyze objects for needs, problems, and/or solutions. The process model regulation system 108 may further identify subject-specific formats and/or gather data in subject-specific formats appropriate to various subjects. The process model regulation system 108 may create cross-functional process models for various needs, problems, solutions, etc. associated with different objects and/or based on the settings and preferences of various subjects. In some implementations, the process model regulation system 108 stores cross-functional process models in the cross-functional process datastore 118.

The context-aware service toolkit 110 may operate to provide a subject with a virtual assistant to address needs, problems, and/or provide solutions relevant to a service context between the object 104 and any subjects. The context-aware service toolkit 110 may allow the subject to enter notes, voice commands and/or other natural language, photos, video, text input, etc. The context-aware service toolkit 110 may provide an artificially intelligent chatbot that captures the inputs described herein. In various implementations, context-aware service toolkit 110 may operate to gather cross-functional process data from the cross-functional process datastore 118. The context-aware service toolkit 110 may further receive from a subject object-specific servicing parameter value, which may be in a subject-specific format. As an example, the object-specific servicing parameter value may be customized to a subject's natural language patterns, behavior patterns, etc.

The context-aware service toolkit 110 may receive from the service professional one or more object-specific servicing parameter values in a subject-specific format that is related to the object 104. The object-specific servicing parameter values may provide a basis to service the object 104 and may arrive at the context-aware service toolkit 110 in the form of photos/video of the object 104, dictated or written mechanics' notes related to the object 104, etc. The context-aware service toolkit 110 may provide the object-specific servicing parameter values to the process model execution system 112, which may conduct a process model activity of the first sub-process model of the cross-functional process model using the first object-specific servicing parameter value in the domain-restricted format.

The process model execution system 112 may operate to implement a cross-functional process model for a particular servicing context. The servicing context may be associated with various needs, problems, solutions, etc. of different objects and/or based on the settings and preferences of various subjects. In some implementations, the cross-functional process model data used by the context-aware service toolkit 110. The cross-functional process model data may provide chat data, guided Internet searches, guided service process steps, etc. for an artificially intelligent chatbot executing on the context-aware service toolkit 110.

In some implementations, the process model execution system 112 may obtain from the process model activity engine a second object-specific parameter associated with the second sub-process model of the cross-functional process model, and may prompt the subject device(s) 106 to provide a second object-specific parameter value. The process model execution system 112 may obtain from the subject device(s) 106 the second object-specific parameter value in the subject-specific format. In some implementations, the process model execution system 112 may continue operation of its process model activity until termination of the cross-functional process model. The process model execution system 112 may be trained by the process model regulation system 108.

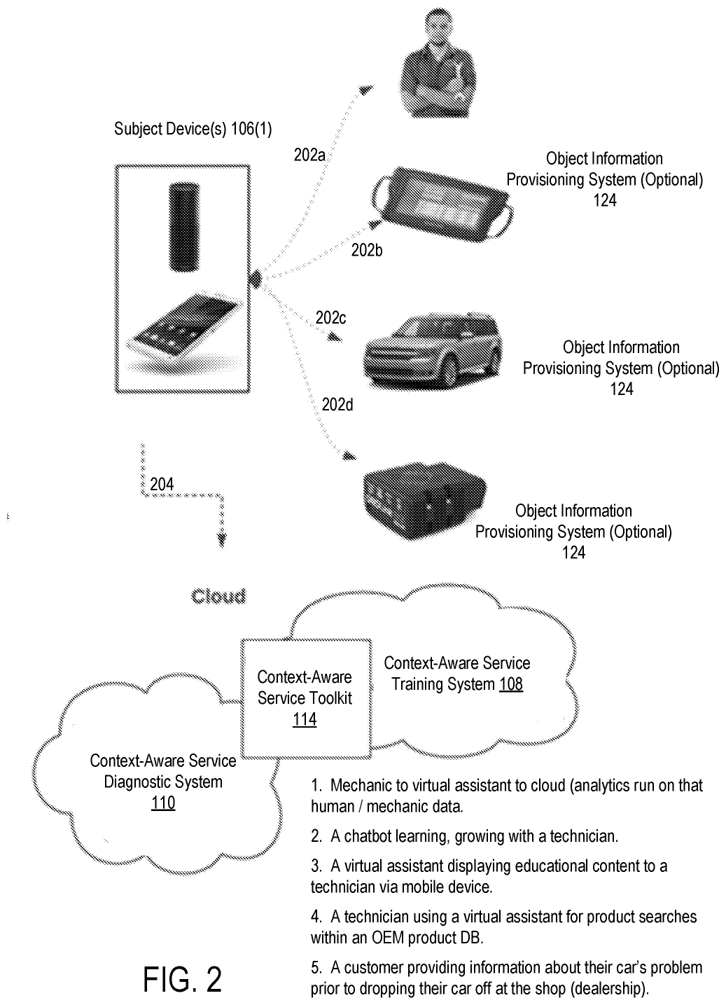

FIG. 2 shows an example of a flowchart 200 of a method for processing context-based servicing parameters. The method is shown in conjunction with the structure of context-aware service environment 100 shown in FIG. 1 and discussed further herein. It is noted the method may have additional or fewer operations than those shown in FIG. 2. Additionally, it is noted that structures other than those shown in FIG. 1 may perform the operations shown in FIG. 2.

At an operation 202 (shown in FIG. 2 as operations 202a, 202b, 202c, and 202d), the subject device(s) 106 may collect and digitize context-based servicing parameters from the object information provisioning system 124 and/or objects 104. As an example, a subject device(s) 106 may comprise a voice activated smart speaker from which an automobile mechanic may use special wake words to send search queries to. The subject device(s) 106 may record and/or digitize the mechanic's voice snippet. As another example, the subject device(s) 106 may comprise an Android smart phone and the object information provisioning system 124 may comprise a Bluetooth-connected OBD-II reader. An automobile mechanic may use a chatbot application to read/download OBD-II code (context-based servicing parameter) from the reader. In yet another implementation, the same Android phone, the same aforementioned chatbot application with optical character recognition (OCR) capability, may extract a vehicle's VIN number from scanning a vehicle's VIN tag using Android smart phone's built-in camera.

At an operation 204, the subject device(s) 106 may the transmit context-based servicing parameter to the process model execution system 112 and/or the process model regulation system 108 via the computer-readable medium 102. The process model execution system 112 may process a context-based servicing parameter (i.e. the search query/question), perform information retrieval analysis (i.e. comparing search terms with various datastores and retrieve the matching result), and return a context-aware processing content (i.e. the search result/answer) back to the subject device(s) 106. For example, an automobile mechanic may either command a smart speaker or a chatbot to retrieve a vehicle history with a VIN—the context-based servicing parameter. The process model execution system 112 processes the context-based servicing parameter using language information stored in the NLP data datastore(s) 118, compares the vehicle VIN with vehicle information stored in the public vehicle data datastore(s) 120, retrieves and relays the vehicle history information back to the subject device(s) 106—the context-aware processing content. In this example, the smart speaker “speaks out” the pertinent vehicle history or the chatbot displays the pertinent vehicle history.

In some implementations, the subject device(s) 106 may also transmit context-based servicing parameter to the process model regulation system 108 via the computer-readable medium 102. The information stored in the cross-functional process datastore 118 may be used for future artificial intelligence training or to improve future information retrieval accuracy.

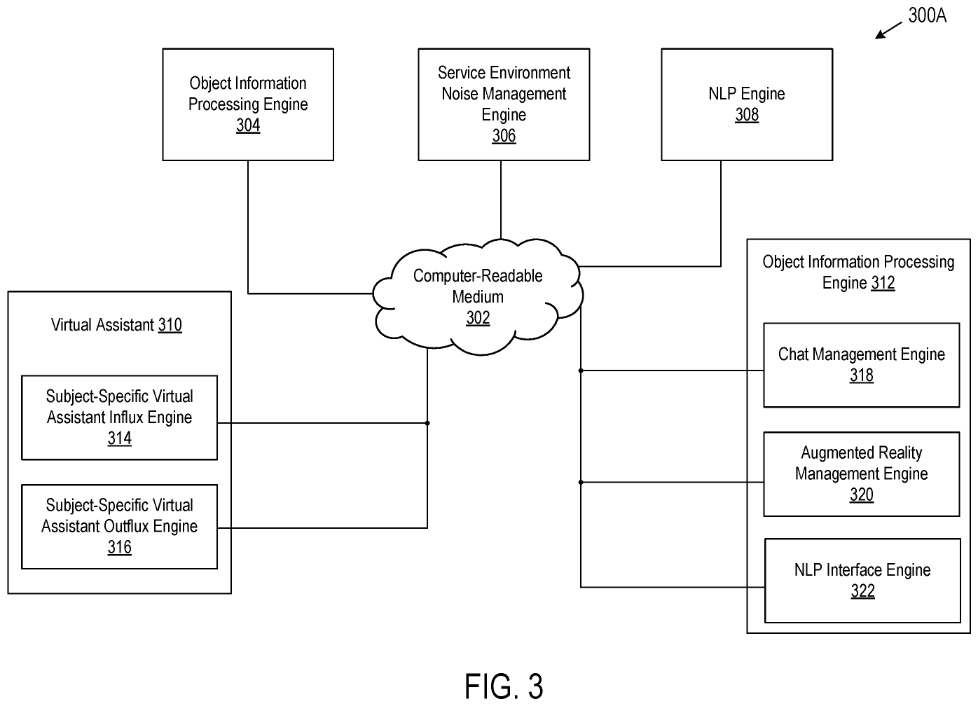

FIG. 3 shows an example of a context-aware service toolkit 300. The context-aware service toolkit 300 may include a computer-readable medium 302, an object information processing engine 304, a service environment noise management engine 306, a virtual assistant engines 310, and an object information processing engines 312. In the example of FIG. 3, the modules are coupled to one another over the computer-readable medium 302.

In a specific implementation, the object information processing engine 304 may be configured to gather object information about objects. The object information processing engine 304 may control an object information provisioning interface and provides instructions to gather the object information, either directly or through an object information provisioning system. The object information processing engine 304 may provide the object information to other modules in the context-aware service toolkit 300.

In a specific implementation, the service environment noise management engine 306 may be configured to filter noise in a service environment. The service environment noise management engine 306 may include hardware and/or software filters that identify specific frequencies corresponding to noise. The service environment noise management engine 306 may further attenuate and/or block sounds that fall within those frequencies. In some implementations, the service environment noise management engine 306 is configured to cooperate with bone-conducting headphones.

In a specific implementation, the virtual assistant engines 310 may manage a virtual assistant for a specific service context. The virtual assistant may support artificially intelligent processes that automate service of objects by subjects. In some implementations, the virtual assistant comprises one or more of an artificially intelligent chatbot, automated and/or online mechanics' notes, executable programs that guide subjects through structured Internet and/or database queries relevant to a service context, etc.

The virtual assistant engines 310 may include a subject-specific virtual assistant influx engine 314 and a subject-specific virtual assistant outflux engine 316. In various implementations, the subject-specific virtual assistant influx engine 314 may receive object-specific servicing parameter values and may convert these object-specific servicing parameter values from subject-specific formats to domain-restricted formats. The subject-specific virtual assistant influx engine 314 may provide these object-specific servicing parameter values to other modules, such as the object information processing engines 312. The subject-specific virtual assistant outflux engine 316 may prompt a subject to provide object-specific parameter values. In some implementations, the prompt may occur within artificially intelligent processes that automate service of objects by subjects. The prompt may occur within chatbots, etc.

The object information processing engines 312 may be configured to provision object information to other modules. In the example of FIG. 3, the object information processing engines 312 includes a chat management engine 318, an AR management engine 320, and an NLP interface engine 322. The chat management engine 318 may provide data for an artificially intelligent chatbot. The AR management engine 320 may provide data for AR hardware and/or software on a subject device. The NLP interface engine 322 may provide data to support NLP capabilities on a subject device and may interface with microphones, speakers, headphones, etc. to capture and process NLP content.

The modules of the context-aware service toolkit 300 may operate support automating service of an object. The object information processing engine 304 may operate to gather object information about objects. The service environment noise management engine 306 may operate to reduce noise due to a service environment. The subject-specific virtual assistant influx engine 314 may operate to gather object-specific servicing parameter value in a subject-specific format from a subject. The subject-specific virtual assistant outflux engine 316 may operate to prompt subjects to gather object-specific parameter values. The object information processing engines 312 may provide chat features (e.g., the chat management engine 318), AR management (e.g., the AR management engine 320) and/or NLP support (e.g., the NLP interface engine 322).

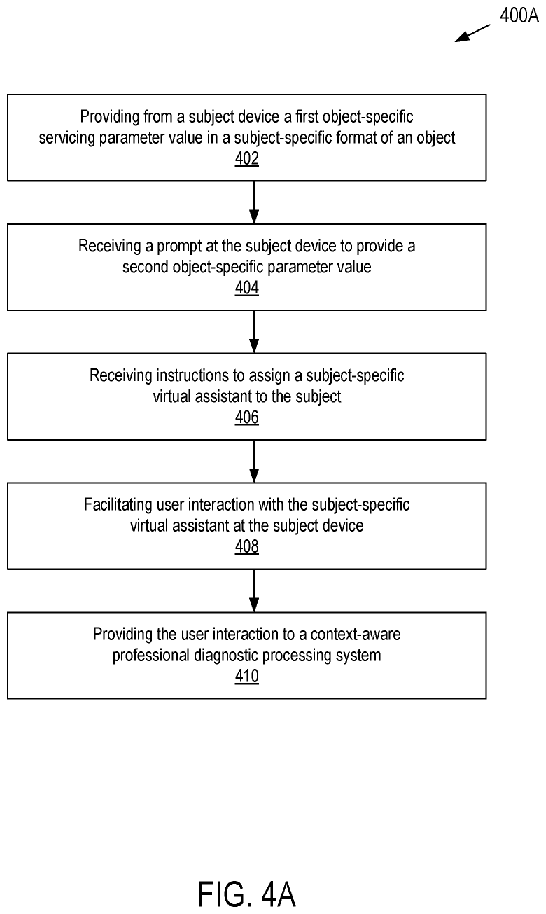

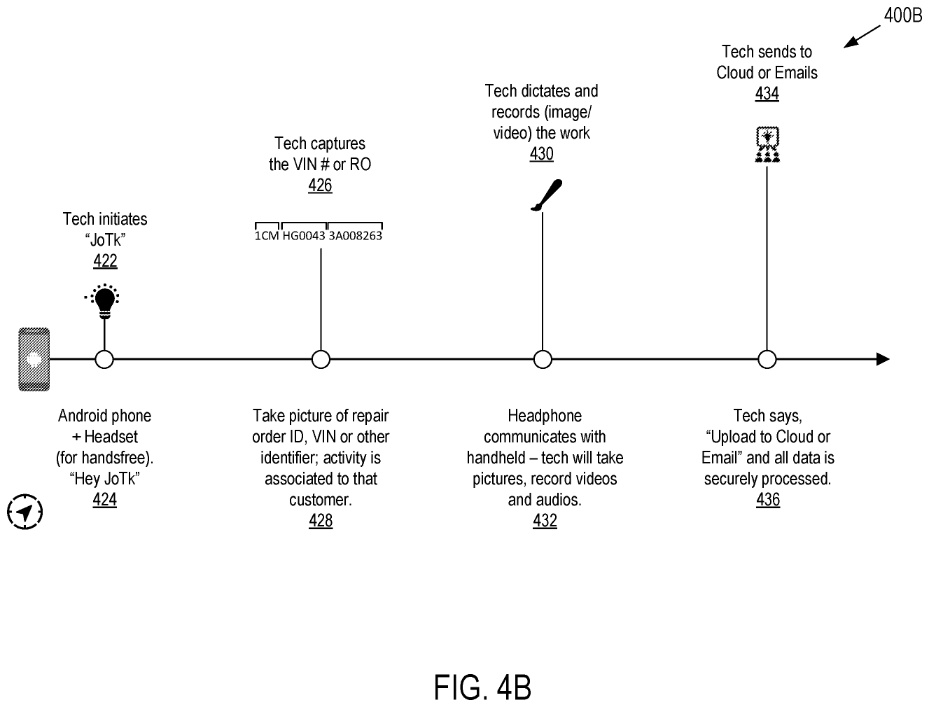

FIG. 4A shows an example of a flowchart 400A of a method for providing a user interaction to a context-aware professional diagnostic processing system. It is noted the operations in the flowchart 400A are by way of example only, and that various implementations may include a greater or fewer number of operations. At an operation 402, a first object-specific servicing parameter value in a subject-specific format of an object may be provided from a subject device. In some implementations, a subject device may be configured to capture NLP content, photos, videos, chatbot inputs, etc. that are related to a specific object. The captured content may be in a subject-specific format that is associated with appropriate format of the subject device. The captured content may be captured by a chatbot, an AR/MR system, etc.

At an operation 404, a prompt may be received at a subject device to provide a second object-specific parameter value. The prompt may include a request to service an object. The request may be formatted in a way that is relevant to service of the object, and/or in an object-specific format. The prompt may be provided in a chatbot or other user interface element of the subject device. In some implementations, a prompt is received in an AR/MR UI.

At an operation 406, instructions to assign a subject-specific virtual assistant to the subject are received. The subject-specific virtual assistant may be configured to accommodate the NLP patterns, behavior patterns, etc. of a subject. In some implementations, the subject-specific virtual assistant is configured to receive data from the subject in a subject-specific format that is particular to that subject.

At an operation 408, user interactions with the subject-specific virtual assistant are facilitated at the subject device. In various implementations, a chatbot receives textual, messaging, and/or other types of input in a subject-specific format. The subject-specific format may include words, pictures, NLP patterns, etc. that are particular to the ontology of the subject. At an operation 410, the user interaction is provided to a process model execution system.

FIG. 4B shows an example of a flowchart 400B of a method for providing a user interaction to a context-aware professional diagnostic processing system. It is noted the operations in the flowchart 400B are by way of example only, and that various implementations may include a greater or fewer number of operations. At an operation 422, a service professional may initiate a subject-specific virtual assistant. At an operation 424, the service professional may provide NLP commands to the subject-specific virtual assistant. At an operation 426, a technician may capture a VIN or a RO. At an operation 428, a picture of a repair order ID, VIN or other identifier, activity is associated to a customer. At an operation 430, a tech dictates and records, images, and/or videos the work. At an operation 432, the headphone communicates with the handheld, the tech will take pictures, record video and audio. At an operation 434, the tech may send the data to a cloud account or may email the data. At an operation 436, the tech may say “upload to cloud or email,” and all data is securely processed.

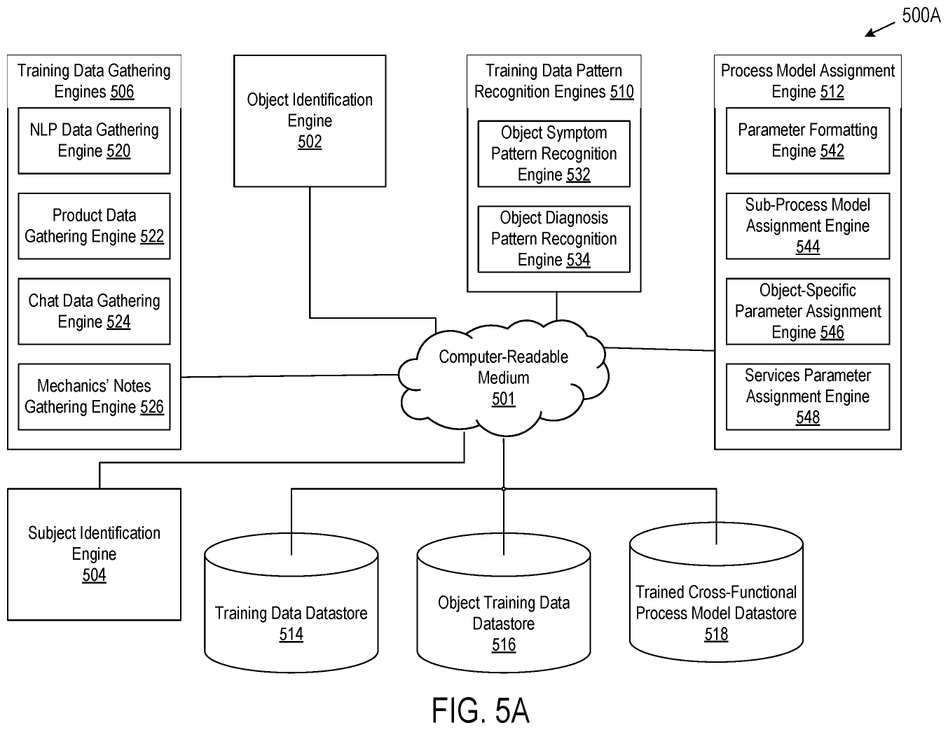

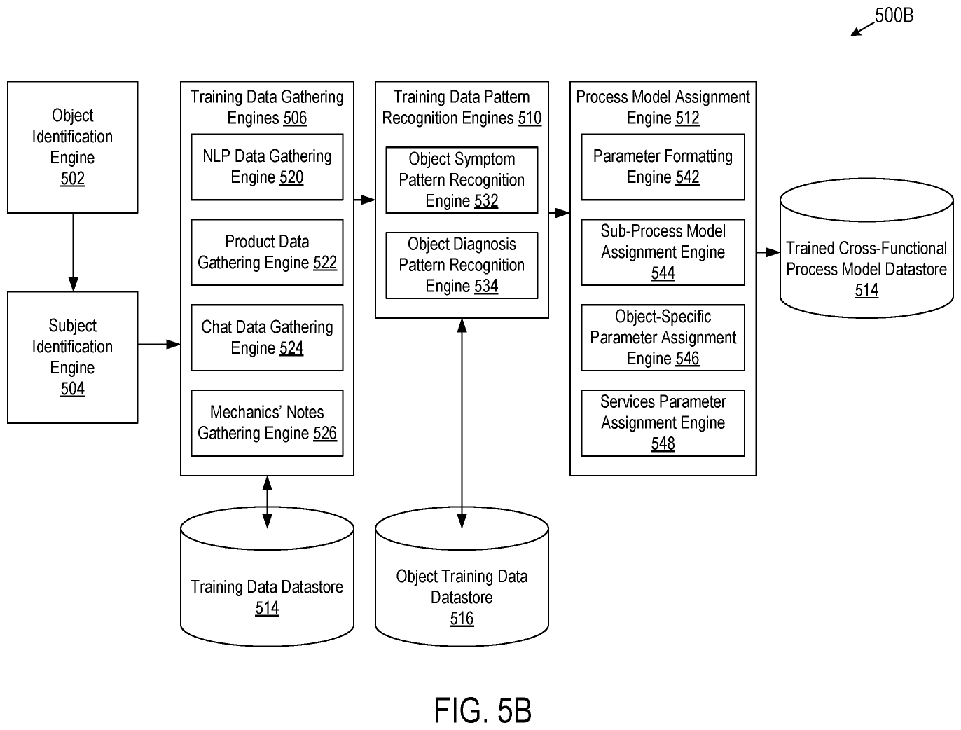

FIG. 5A shows an example of a process model regulation system 500. In the example of FIG. 5A, the process model regulation system 500 includes a computer-readable medium 501, an object identification engine 502, a subject identification engine 504, a training data gathering engines 506, training data pattern recognition engines 510, process model assignment engines 512, a training data datastore 514, an object training data datastore 516, and a trained cross-functional process model datastore 518. The computer-readable medium 501 may couple the modules of the process model regulation system 500A to one another.

In a specific implementation, the object identification engine 502 is configured to identify objects. The object identification engine 502 may gather the universe of objects from an object datastore. The universe of objects may comprise all objects that cross-functional process models are to be created for. The object identification engine 502 may gather data from product manuals, Internet sources, social media accounts, etc.

In a specific implementation, the subject identification engine 504 is configured to identify subjects. The subject identification engine 504 may gather the universe of subjects from a subject datastore. The universe of subjects may comprise all subjects that cross-functional process models are to be created for. The subject identification engine 504 may gather data from product manuals, Internet sources, social media accounts, etc. The subject identification engine 504 may also gather data from personnel accounts, employment accounts, and/or other similar sources.

The training data gathering engines 506 may include engines configured to gather training data from the training data datastore 514. The “training data,” as used herein, may include information about objects as well as information about subjects. In the example of FIG. 5A, the training data gathering engines 506 include a NLP data gathering engine 520, a chat data gathering engine 522, and a mechanics' notes gathering engine 526.

The NLP data gathering engine 520 may be configured to gather NLP data from the training data datastore 514. The NLP data may include NLP patterns used by different subjects in different contexts in relation to an object. The NLP data may include NLP patterns used by a single subject in different contexts in relation to different objects. The chat data gathering engine 522 may be configured to gather historical and/or other chat data from the training data datastore 514. The chat data may include chat conversations and/or patterns used by different subjects in different contexts in relation to an object. The chat data may include chat conversations and/or patterns used by a single subject in different contexts in relation to different objects. The mechanics' notes gathering engine 524 may similarly be configured to gather historical and/or other mechanics' notes form the training data datastore 514. Those mechanics' notes may include notes about from a single subject or about a single object.

The training data pattern recognition engines 510 may include engines configured to train other modules to recognize patterns in training data. In the example of FIG. 5A, the training data pattern recognition engines 510 include an object symptom pattern recognition engine 532 and an object diagnosis pattern recognition engine 534. The object symptom pattern recognition engine 532 may be configured to identify symptom patterns of objects, e.g., how NLP patterns, chat data patterns, and mechanics' notes patterns correlate with problems and/or symptoms observed with objects. The object diagnosis pattern recognition engine 534 may be configured to identify diagnosis patterns of objects, e.g., how patterns, chat data patterns, and mechanics' notes patterns correlate with solutions and/or diagnoses of problems and/or symptoms observed with objects.

The process model assignment engines 512 may include engines configured to train a cross-functional process model using patterns recognized in training data. In the example of FIG. 5A, the process model assignment engines 512 include a parameter formatting engine 542, a sub-process model assignment engine 544, an object-specific parameter assignment engine 546, and a services parameter assignment engine 548. The parameter formatting engine 542 may be configured to format parameters appropriately, e.g., in subject-specific formats, domain restricted formats etc. The sub-process model assignment engine 544 may be configured to assign a sub-process model to an object-subject pair. The object-specific parameter assignment engine 546 may assign object-specific parameters to objects based on the properties of those objects. The services parameter assignment engine 548 may be configured to assign services parameters to object-subject pairs depending on relevant context.

The trained cross-functional process model datastore 518 may be configured to store trained cross-functional process models for objects, subject, and/or contexts.

FIG. 5B shows an example of the operation of the process model regulation system 500. In this example, the object identification engine 502 may operate to gather identifiers of objects for a cross-functional process model. The object identification engine 502 may provide the identifiers of those objects to the training data gathering engines 506. The subject identification engine 504 may operate to gather identifiers of subjects for the cross-functional process model. The subject identification engine 504 may provide the identifiers of those subjects to the training data gathering engines 506.

The training data gathering engines 506 may operate to gather training data from the training data datastore 514. In some implementations, the NLP data gathering engine 520 gathers NLP data from the training data datastore 514. The chat data gathering engine 522 may operate to gather chat data from the training data datastore 514. The mechanics' notes gathering engine 524 may operate to gather mechanics' notes from the training data datastore 514. The training data gathering engines 506 may provide the training data to the training data pattern recognition engines 510.

The training data pattern recognition engines 510 may operate to recognize patterns in the training data. The object symptom pattern recognition engine 532 may operate to recognize patterns in NLP data, chat data, mechanics' notes, etc. in order to analyze/identify problems and/or symptoms associated with objects. The object diagnosis pattern recognition engine 534 may operate to recognize patterns in NLP data, chat data, mechanics' notes, etc. in order to analyze/identify solutions and/or diagnoses of problems/symptoms associated with objects. The training data pattern recognition engines 510 may provide relevant patterns of training data to the process model assignment engines 512.

The process model assignment engines 512 may operate to assign trained cross-functional process model to various contexts. The parameter formatting engine 542 may operate to format parameters in accordance with training data. The sub-process model assignment engine 544 may operate to assign a sub-process model. The object-specific parameter assignment engine 546 may operate to assign object-specific parameters. The services parameter assignment engine 548 may operate to assign services parameters. In various implementations, the process model assignment engines 512 may store a cross-functional process model in the trained cross-functional process model datastore 518.

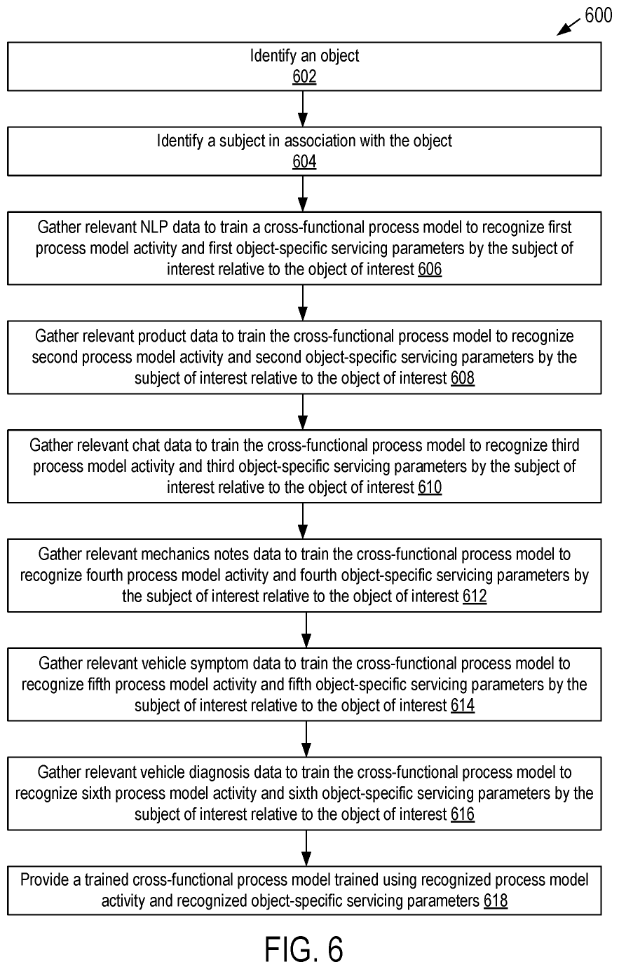

FIG. 6 shows an example of a flowchart 600 of a method for training a context-aware professional diagnostic training system. It is noted the operations in the flowchart 600 are by way of example only, and that various implementations may include a greater or fewer number of operations.

At an operation 602, an object may be identified. At an operation 604, a subject may be identified in association with the object.

At an operation 606, relevant NLP data may be gathered to train a cross-functional process model to recognize first process model activity and first object-specific servicing parameters by the subject of interest relative to the object of interest. At an operation 608, relevant product data may be gathered to train the cross-functional process model to recognize second process model activity and second object-specific servicing parameters by the subject of interest relative to the object of interest.

At an operation 610, relevant chat data may be gathered to train the cross-functional process model to recognize third process model activity and third object-specific servicing parameters by the subject of interest relative to the object of interest. At an operation relevant mechanics notes data may be gathered to train the cross-functional process model to recognize fourth process model activity and fourth object-specific servicing parameters by the subject of interest relative to the object of interest.

At an operation 614, relevant vehicle symptom data may be gathered to train the cross-functional process model to recognize fifth process model activity and fifth object-specific servicing parameters by the subject of interest relative to the object of interest.

At an operation 616, relevant vehicle diagnosis data may be gathered to train the cross-functional process model to recognize sixth process model activity and sixth object-specific servicing parameters by the subject of interest relative to the object of interest. At an operation 618, a trained cross-functional process model trained using recognized process model activity and recognized object-specific servicing parameters may be provided and/or stored.

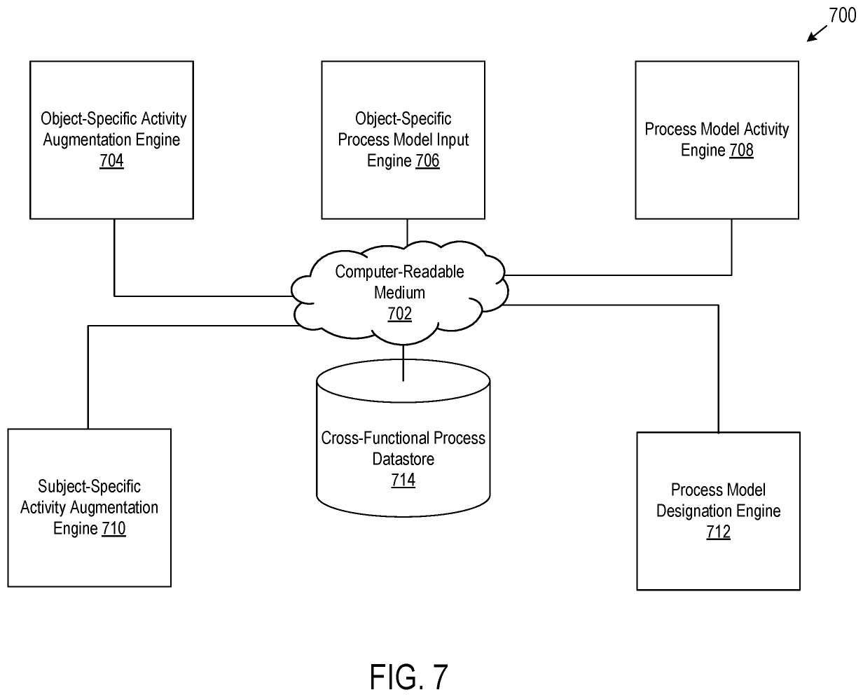

FIG. 7 shows an example of a process model execution system 700. In the example of FIG. 7, the process model execution system 700 includes a computer-readable medium 702, an object-specific activity augmentation engine 704, an process model agency engine 706, a process model activity engine 708, a subject-specific activity augmentation engine 710, a process model designation engine 712, a process model agency engine 714, and a cross-functional process datastore 716.

The object-specific process model input engine 704 may be configured to gather from subject devices one or more object-specific servicing parameter values. The object-specific servicing parameter values may be formatted in a subject-specific format for an object. The object-specific servicing parameter values may provide a basis for a subject to service an object. In various implementations, the object-specific servicing parameter values are associated with a subject (e.g., a serviceperson). The object-specific servicing parameter values may include specific data about an object.

The process model agency engine 706 may be configured to gather object-specific parameters associated with sub-process models of a cross-functional process model. In various implementations, the process model agency engine 706 gathers these items from the cross-functional process datastore 716. The process model activity engine 708 may be configured to conduct process model activities of the sub-process models of the cross-functional process model using object-specific servicing parameter values. The object-specific servicing parameter values may be in a domain-restricted format and/or other relevant or applicable formats.

The subject-specific activity augmentation engine 710 may be configured to augment subject-specific activity. The process model designation engine 712 may be configured to identify one or more cross-functional process models. The cross-functional process models may have a plurality of sub-processes, each corresponding to service tasks, for instance. The cross-functional process datastore 716 may be configured to store trained cross-functional process models for objects, subject, and/or contexts.

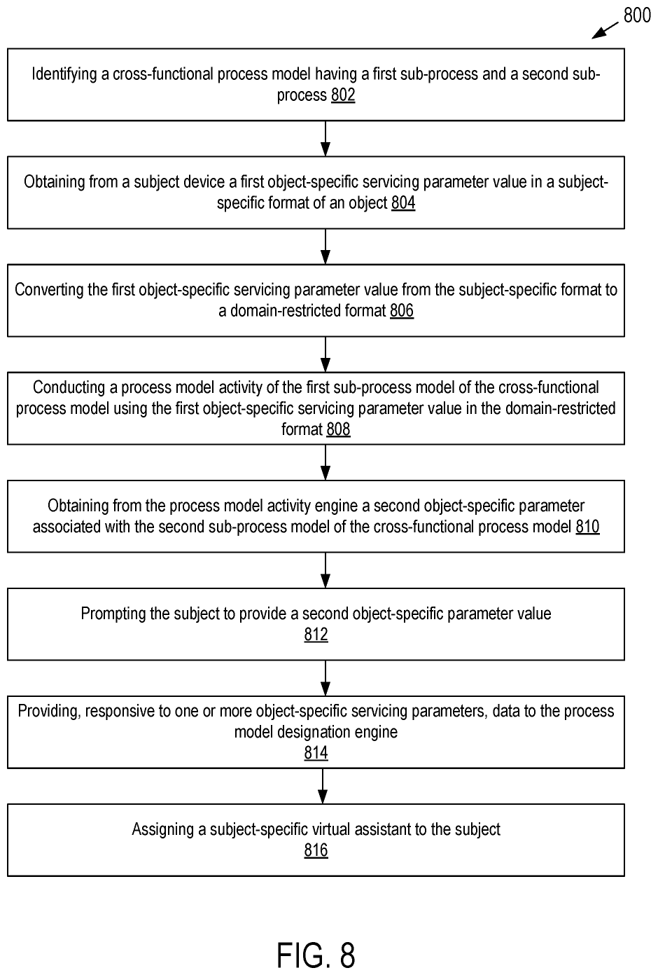

FIG. 8 shows an example of a flowchart 800 of a method for assigning a subject-specific virtual assistant to a subject. It is noted the operations in the flowchart 600 are by way of example only, and that various implementations may include a greater or fewer number of operations.

At an operation 802, a cross-functional process model having a first sub-process and a second sub-process may be identified. At an operation 804, a first object-specific servicing parameter value in a subject-specific format of object may be obtained from a subject device. At an operation 806, the first object-specific servicing parameter value may be converted from the subject-specific format to a domain-restricted format. At an operation 808, a process model activity of the first sub-process model of the cross-functional process model may be conducted using the first object-specific servicing parameter value in the domain-restricted format.

At an operation 810, a second object-specific parameter associated with the second sub-process model of the cross-functional process model may be obtained from the process model activity engine. At an operation 812, the subject may be prompted to provide a second object-specific parameter value. At an operation 814, data may be provided, in response to the one or more servicing parameters, to the process model designation engine. At an operation 816, a subject-specific virtual assistant may be assigned to the subject.

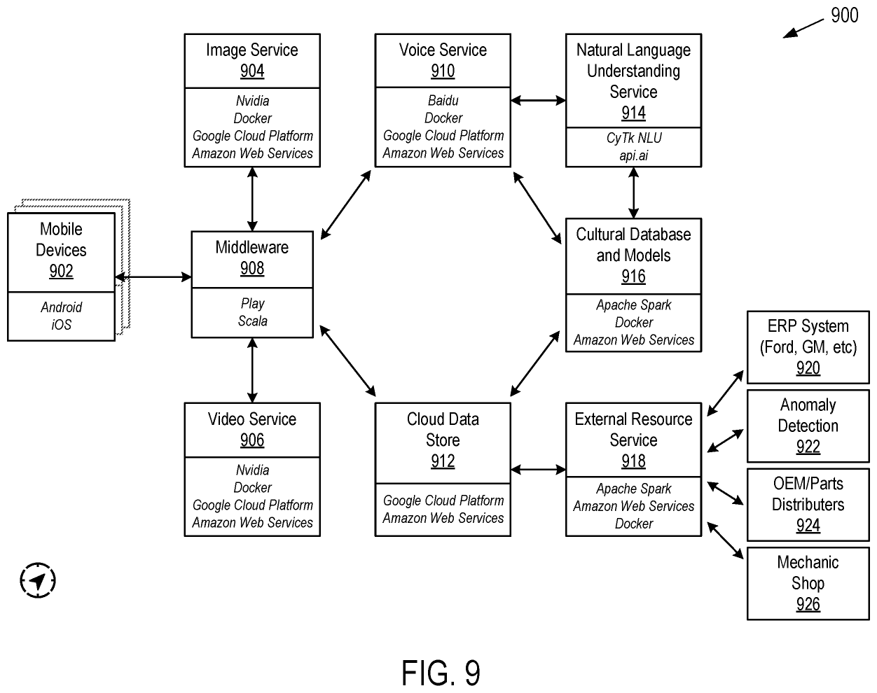

FIG. 9 shows an example of a software platform 900 for a context-aware service environment. The software platform 900 may include mobile devices 902, an image service 904, a video service 906, middleware 908, a voice service 910, a cloud data store 912, a NLP understanding service 914, cultural database and models 916, an external resource service 918, an ERP system 920, an anomaly detection system 922, an OEM/parts distribution system 924, and a mechanic shop 926.

Several components described in this paper, including clients, servers, and engines, may be compatible with or implemented using a cloud-based computing system. As used in this paper, a cloud-based computing system is a system that provides computing resources, software, or information to client devices by maintaining centralized services and resources that the client devices may access over a communication interface, such as a network. The cloud-based computing system may involve a subscription for services or use a utility pricing model. Users may access the protocols of the cloud-based computing system through a web browser or other container application located on their client device.

This paper describes techniques that those of skill in the art may implement in numerous ways. For instance, those of skill in the art may implement the techniques described in this paper using a process, an apparatus, a system, a composition of matter, a computer program product embodied on a computer-readable storage medium, or a processor, such as a processor configured to execute instructions stored on or provided by a memory coupled to the processor. Unless stated otherwise, a component such as a processor or a memory described as being configured to perform a task may be implemented as a general component that is configured to perform the task at a given time or a specific component that is manufactured to perform the task. As used in this paper, the term ‘processor’ refers to one or more devices, circuits, or processing cores configured to process data, such as computer program instructions.

A detailed description of one or more implementations of the invention is provided in this paper along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus may be specially constructed for the required purposes, or it may comprise a general-purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus. Although the foregoing implementations have been described in some detail for purposes of clarity of understanding, implementations are not necessarily limited to the details provided.

What is claimed is:

1. A system comprising:
a process model designation engine configured to identify a cross-functional process model having a first sub-process model and a second sub-process model;
an object-specific process model input engine configured to obtain from a subject device a first object-specific servicing parameter value in a subject-specific format of an object, wherein the subject device is associated with a subject, the first object-specific servicing parameter value is associated with a first servicing parameter of one or more process models, at least one of which is the cross-functional process model, and the subject-specific format is that of the subject;
a subject-specific virtual assistant influx engine configured to convert the first object-specific servicing parameter value from the subject-specific format to a domain-restricted format;
a process model activity engine configured to conduct a process model activity of the first sub-process model of the cross-functional process model using the first object-specific servicing parameter value in the domain-restricted format;
a process model agency engine configured to obtain from the process model activity engine a second object-specific parameter associated with the second sub-process model of the cross-functional process model;
a subject-specific virtual assistant outflux engine configured to prompt the subject to provide a second object-specific parameter value, wherein the object-specific process model input engine is further configured to obtain from the subject device the second object-specific parameter value in the subject-specific format;
wherein, in operation, process model activity engine continues operation until termination of the cross-functional process model.

2. The system of claim 1, wherein the object is a vehicle, and the subject is a professional identified as responsible for servicing the vehicle.

3. The system of claim 1, comprising a servicing issue diagnostics engine configured, responsive to one or more object-specific servicing parameters, to provide data to the process model designation engine, wherein, in operation, the process model designation engine uses the data from the servicing issue diagnostics engine to identify the cross-functional process model.

4. The system of claim 1, comprising a virtual assistant provisioning engine configured to assign a subject-specific virtual assistant to the subject.

5. The system of claim 1, wherein, in operation, the process model designation engine identifies the object prior to the subject providing the first object-specific servicing parameter value, identifies the object using the first object-specific servicing parameter value, or identifies the object using some other object-specific servicing parameter value.

6. The system of claim 1, wherein the subject device includes one or more of a smartphone, a subject-specific augmented reality component, a context-appropriate sensor component, and a context-appropriate feedback component.

7. The system of claim 1, wherein the one or more process models include a catch-all process model associated with an as-of-yet unsettled process model.

8. The system of claim 1, wherein conducting the process model activity includes executing automated activities.

9. The system of claim 1, wherein the cross-functional process model includes a third sub-process model associated with a third party system.

10. The system of claim 1, wherein conducting the process model activity includes identifying an activity-specific servicing parameter value in a domain-restricted format, and wherein the subject-specific virtual assistant outflux engine converts the activity-specific servicing parameter value from the domain-restricted format to the subject-specific format.

13. The system of claim 1, comprising a subject-specific activity augmentation engine configured to provide information associated with an incomplete activity of the second sub-process model to the subject-specific virtual assistant outflux engine.

14. The system of claim 1, comprising converting the object-specific servicing parameter value from the domain-restricted format to a universal format, wherein the domain-restricted format is an enterprise-specific format.

15. The system of claim 1, comprising converting the object-specific servicing parameter value from the domain-restricted format to an enterprise-specific format, wherein the domain-restricted format is a universal format.

16. The system of claim 1, comprising a training engine configured to train one or more of an object datastore, a virtual assistant, an enterprise ontology, a universal ontology, and an activity augmentation datastore, using a set of historical data associated with one or more subjects, a set of ascertainable data associated with one or more objects, or a set of enterprise-specific policies.
